(19) United States
(12) Patent Application Publication
(10) Pub. No.: US 2024/0054195 A1
(43) Pub. Date: Feb. 15, 2024

(54) Authorization of Action by Voice Identification

(71) Applicant: SoundHound, Inc., Santa Clara, CA (US)

(72) Inventors: Ahmadul HASSAN, San Jose, CA (US); James HOM, Palo Alto, CA (US)

(73) Assignee: SoundHound, Inc., Santa Clara, CA (US)

(21) Appl. No.: 17/818,628

(22) Filed: Aug. 9, 2022

(51) Int. Cl. G06F 21/32; G10L 17/12; G06F 3/16

(52) U.S. Cl. CPC G06F 21/32; G10L 17/12; G06F 3/16

(57) ABSTRACT

Actions are authorized by computing a confidence score that exceeds a threshold. The confidence score is based on a match between metadata about requests and fields in corresponding database records. The confidences score weights matches by the dependability of the metadata for authentication. The confidence score is further based on the closeness of a sample of speech audio to a stored voiceprint. Additional identification may be required for authorization. The confidence score requirement may be relaxed based on identification in a buffer of recent action requests.

### SUMMARY

Increasingly many computer automated products and services can be controlled by recognizing speech and interpreting words spoken in human languages. This enables desirable touchless modes of interaction. It also allows for controlling devices with complex functions without learning and remembering how to navigate one or more levels of menus or which of many buttons to use. Users can request actions by voice and receive a positive experience as the product or service is able to complete the requested action.

This is useful for actions as simple as requesting the weather report, as complex as booking a detailed travel itinerary, as commonplace as opening a window, as specialized as controlling a surgical robot, as pleasurable as ordering delicious food from a restaurant, or as unpleasant as paying the credit card bill for the delicious food.

Every action requires some level of access to personal information and might have a lasting effect on somebody's life. Accordingly, some actions are more important than others, and very important actions require more strict authorization than unimportant ones. The description below describes authorization of actions using metadata about user requests and voiceprints of user speech.

### DESCRIPTION OF DRAWINGS

FIG. 1 shows examples of values for the fields in database records.

FIG. 2 shows scenarios of types of actions allowed in different conditions of imperfect matching between requests and database records.

FIG. 3. is a block diagram of one possible implementation.

FIG. 4 shows a user using an implementation over the telephone system.

FIG. 5A shows a processor chip.

FIG. 5B shows a memory chip.

FIG. 6A shows server blades in a chassis.

FIG. 6B a block diagram of a server blade.

### DETAILED DESCRIPTION

The following describes technologies that can authorize a user to perform an action.

The process involves comparing metadata related to a user request to records of user data in a database. Records can include a voiceprint and other metadata such as usernames, phone numbers, and network and geographical locations. A username is an example of metadata that is input directly by the user making the request. A phone number is an example of metadata that can be captured by the Caller ID system for requests made by telephone. Network location is an example of metadata automatically identifiable for requests made over the internet. Geographical location is an example of metadata captured by mobile devices with geolocation capabilities.

Database Matching

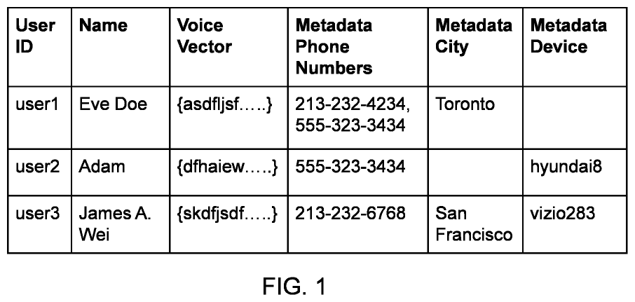

FIG. 1 shows an example of 6 fields of 3 records in a database of user information. The User ID field acts as a primary key in the database. All other fields are optional.

The Voice Vector field can be used to perform voice identification. The field might include the voice vector directly or the field might point to a different source for the voice vector. For example, a separate third party service provider might store voice vectors and perform voice fingerprint analysis. The Voice Vector field with records is not necessary. Some users might enroll in the database through typing or other means that do not use voice. Also, some users might not consent to having their voiceprint stored.

Voiceprint matching is a fuzzy matching technique. Its accuracy decreases as the database grows. Matching other data is an exact match process, which scales well. For run-time matching of a user to a record, it is only necessary to have a value for at least one field in each record. Some implementations will require metadata to match to multiple fields or require request metadata for some fields.

Some examples of fields that might be useful in different implementations or different scenarios are Name, Phone Number, City, Home Address, Email Address, IP Address, Device Type, and Device ID.

The values of some fields in the database may be written by or read from one or more providers. For example, a phone number can be found from a digital wallet service and from a connected device such as a car or smart TV Service.

Matching metadata from a user request to fields in database records, even for exact matches, are not perfectly dependable ways to verify the user's identity. There can be ambiguity if a data value appears for multiple records. For example, multiple records may have the same value for the Home Phone Number field in records for multiple users who live in the same home. It is even possible, for example, to have a Phone Number match to a single database record but that the user is not associated with the record because the user is using somebody else's phone.

Authorization of actions using voice identification requires a 2-step process.
1. Metadata matching: Search the database for records that match the metadata available with the user's request to find a set of potential matching records.
2. Voice fingerprint comparison: From the set of potential matching records, compare the records' saved voiceprints to a voiceprint computed from speech audio with the user's request.

Neither step is perfectly accurate. Metadata matching produces a dependability score representing how dependable the matches of available metadata to database record fields is for uniquely identifying a record for the user. Voice fingerprint comparison computes a closeness between a voiceprint of the speech audio with the user request and the voiceprint associated with the database record. The dependability score and voiceprint closeness are combined to compute a confidence score for a match between the user and the database record for the given request.

It is then possible to authorize an action for the account associated with the record having the highest confidence score. Alternatively or additionally, the authorization can depend on the confidence score exceeding an action confidence threshold. Different actions may have different thresholds. This would be appropriate when different actions have different levels of importance or different severities in case of an incorrect identification of the user.

In one implementation, confidence is assessed in three discrete levels.
Low confidence is for a request having no record with a confidence score above a threshold for identifying a user.
Medium confidence is for a request having a confidence score with multiple records above the threshold. This indicates that the user probably matches a database record, but it is not known which one.
High confidence is for a request for which a single database record has a confidence score above the threshold. This indicates a likely exact match.

Translating numerical scores for each step into broad discrete levels discards information. However it makes it easy for designers to simply assign actions to classes based on confidence level.

Actions

This brings us to action classes. The nature of user identification described above means that there is always uncertainty as to whether the user has been correctly identified by a matching database record. The confidence score can be used to determine if the action is permitted. Some implementations may have, for example, three classes of actions.
Regular actions are low-stakes actions where mis-identifying a user would not do significant harm. An example of a regular action is reviewing past restaurant orders. This can be permitted for requests having a medium or high confidence level.
Privileged actions are actions that would typically be done on behalf of a user. An example of a privileged action is paying for an order. Making payments may be permitted for requests with a medium or high confidence level. However, if a medium level confidence might trigger additional checks/challenges that would not be required for a high confidence level. An example of such a challenge is to provide the card verification code (CVC) for a saved credit card number.
Restricted actions are actions that access sensitive information such as personal information. An example of a restricted action is trying to access a saved credit card number or personally identifiable information. Restricted access would be only permitted for requests with a high confidence level. Some applications can always require additional authentication, such as providing a PIN or password, for restricted action.

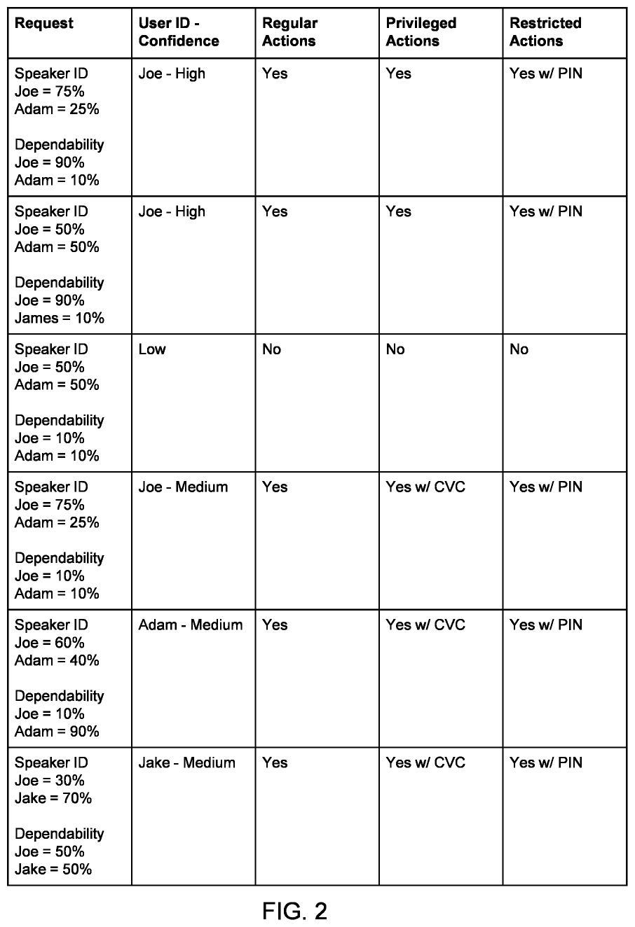

FIG. 2 shows a table with some specific examples. Read the table from left to right where the information on the left informs the decisions on the right. Joe, Adam, James, and Jake refer to database records.

Buffering

There is a higher probability that a possible match between a request and a database record is correct if there was a match between a recent prior request and the same database record. That is because users tend to make sequences of requests. Some implementations maintain a buffer of identifiers of recently matched records. The buffered entries may be time stamped and discarded after a period of time over which the recency of a prior request to a record is a low probability indicator of a current match.

Some implementations interact in sessions. For example, a phone call is a session from connection to hang-up. Even within a session or a buffer of recently match records, there may be more than one matching record. If, for example, multiple users are making requests through a phone in a speakerphone mode, different requests might match different records, but having multiple records buffered is still helpful.

Additional Identity Verification

In some implementations, some scenarios of requests will always or sometimes require additional verification. For example, restricted actions could require the user to enter a personal identification number (PIN) before completing authorization.

A confidence score is a measure of trust. Some implementations will compare the confidence score to a high trust threshold. If the confidence score meets or exceeds the threshold then no additional verification is required. However, if the confidence score is below the high trust threshold, the implementation will perform a step of additional identity verification. One example of an additional identity verification is a match against a PIN. Another example is a request for the CVC code that verifies a stored credit card number.

Example Implementation

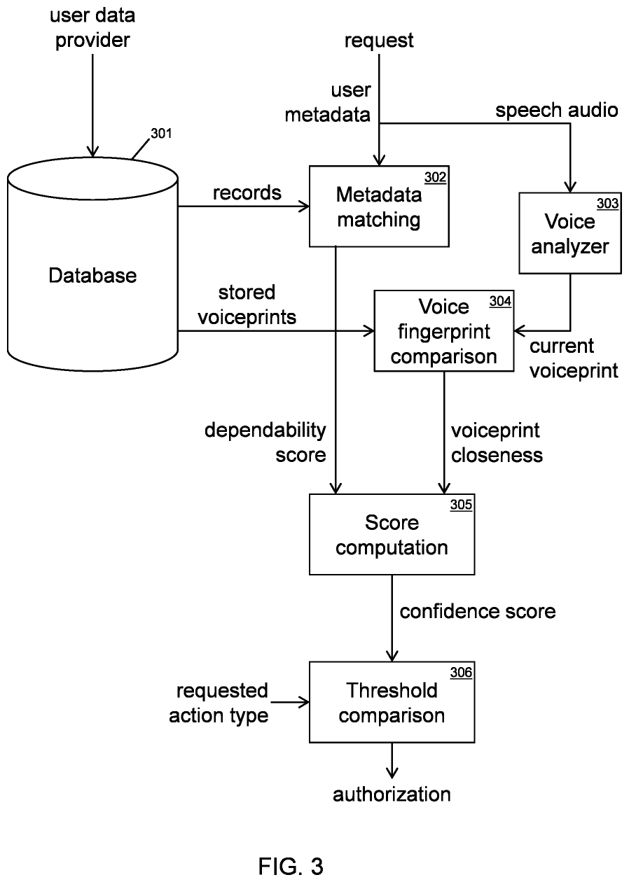

FIG. 3 is a block diagram of an example implementation. It comprises a database 301 of user data. Database records include a voiceprint field, which may optionally have an assigned value. The user data is received from user data providers and written to the database. Requests are received from users. The requests include metadata of data types that match fields of database records.

A metadata matching function 302 searches the database and retrieves records with field values that match the values of data type corresponding to the database fields. Different data types have different dependability weights. For example, an email address has a high dependability weight for matching a record to a user whereas the name of a city has a low dependability weight. A dependability score is computed in a way that produces a higher score for matches of data types having higher weights. One possible simple formula for computing a dependability score would be to add the weight values for each data type that has a match.

The request also includes speech audio. A voice analyzer 303 analyzes the speech audio and computes a voiceprint for the current request. The voiceprint is a text independent representation of the voice as a vector of numbers. Voiceprints can be computed and represented as i-vectors of features of Gaussian mixture model (GMM) features or x-vector or d-vector embeddings extracted from deep neural networks run on the speech audio. In general, a longer period of recorded speech will allow a more precise computation of the voiceprint.

Voiceprints from past requests or from an enrollment process may be stored in database records. For one or more records with a metadata match above a threshold, a voiceprint comparison function 304 retrieves the voiceprints of the matched records, if present, and compares each stored voiceprint to the current voiceprint. One simple method of comparison is to compute a cosine distance between the vectors in a vector feature space. The computed distance indicates the closeness of two voiceprints. A small distance is a high closeness.

A score computation function 305 computes a confidence score for each database record with a dependability score above a threshold. The confidence score is a function of the dependability score and voiceprint closeness. A simple method for computing a confidence score is to add the dependability score and voiceprint closeness. If the scores are on very different scales, a scaling factor could be applied to one or both inputs in order to compute the confidence score. Scores, therefore, are computed according to the data type of the metadata matched to the database record.

Finally, a threshold comparison function 306 identifies the type of action being requested and, from that, a corresponding confidence score threshold. The determination may be one of several action classes or might be a score threshold on a highly granular scale such as a 32-bit or 64-bit number. The confidence score is compared to the threshold for the requested action type. If the confidence score exceeds the threshold, the requested action is authorized. Otherwise, it is not authorized.

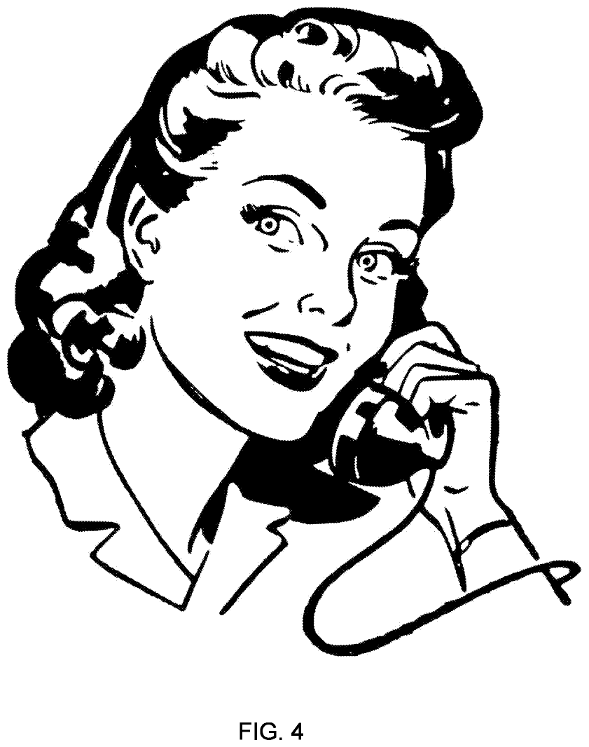

FIG. 4 is a drawing of a user using an implementation in which requests are made by voice over a classic telephone network.

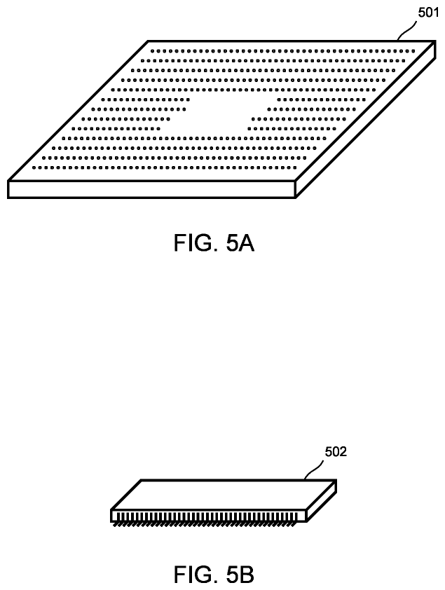

FIG. 5A shows a packaged computer processor chip 501 with a grid array of balls of solder for attaching to a server system.

FIG. 5B shows a Flash random access memory (RAM) chip 502. It is a common type of non-transitory computer readable medium that stores instructions that cause a computer processor to perform methods described herein.

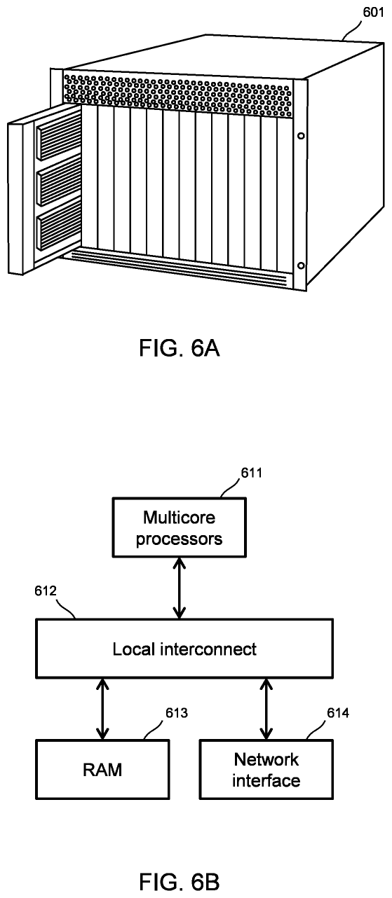

FIG. 6A shows a chassis of a server blade system 601. One blade is partially removed, showing heat sinks attached on top of processor chips. Such a server blade connects processor chips to memory chips that store software as described above.

FIG. 6B shows a block diagram of a server system. It comprises an array of multicore processor chips 611 connected to a local interconnect 612. The processors communicate through the local interconnect with the RAM 613 to read software instructions and store and read data. The processors also communicate through the local interconnect with a network interface 614. Through the network interface, the server can receive requests from users over the internet and send responses. The network interface also allows for connecting between server systems that perform separate functions. For example, one server might perform database searching while another performs voice fingerprinting.

1. A method of authorization, the method comprising:
receiving a request for an action;
receiving metadata relating to the request;
retrieving a record from a database, the record having one or more fields matching the metadata;
computing a dependability score by applying dependability weights to the matched metadata according to the metadata type;
receiving speech audio from the request;
computing a current voiceprint from the speech audio;
reading a stored voiceprint indicated by the record;
computing the voiceprint closeness between the current voiceprint and the stored voiceprint;
computing a confidence score of a match between the request and the record based on the dependability score and the voiceprint closeness; and
authorizing the action in response to the confidence score exceeding an action confidence threshold associated with the action type.

2. The method of claim 1 further comprising requesting an additional identity verification step in response to the confidence score being less than a high trust threshold associated with the action.

3. The method of claim 1 further comprising storing a record identification in a buffer in response to authorizing the action, wherein the confidence score is further based on an identification of the record being present in the buffer.

4. A method of authorization, the method comprising:
receiving a request for an action;
receiving metadata relating to the request;
retrieving a record for an account from a database, the record having one or more fields matching the metadata;
computing a confidence score of a match between the request and the record by applying dependability weights to the metadata according to the metadata type; and
authorizing the action in response to the confidence score exceeding an action confidence threshold associated with the action.

5. The method of claim 4 further comprising requesting an additional identity verification step in response to the confidence score being less than a high trust threshold associated with the action.

6. The method of claim 4 further comprising storing a record identification in a buffer in response to authorizing the action, wherein the confidence score is further based on an identification of the record being present in the buffer.
